(19) United States
(12) Patent Application Publication
(10) Pub. No.: US 2011/0005392 A1
(43) Pub. Date: Jan. 13, 2011

(54) PROCESS FOR SEPARATION OF CO2 BY PRESSURE-MODULATED ADSORPTION ON A POROUS CARBON SOLID

(75) Inventors: Gerhard Pirngruber, Charly (FR); Elsa Jolimaitre, Lyon (FR); Julien Parmentier, Labaroche (FR); Claire Ducrot-Boisgontier, Selestat (FR); Joel Patarin, Flaxlanden (FR)

Correspondence Address: MILLEN, WHITE, ZELANO & BRANIGAN, P.C., 2200 CLARENDON BLVD., SUITE 1400, ARLINGTON, VA, 22201, US

(73) Assignees: CENTRE NATIONAL DE LA RECHERCHE SCIENTIFIQUE, PARIS (FR); IFP, RUEL-MALMAISON (FR)

(21) Appl. No.: 12/820,412

(22) Filed: Jun. 22, 2010

(30) Foreign Application Priority Data
Jun. 22, 2009 (FR) 09/03.009

(51) Int. Cl. B01D 53/047

(52) U.S. Cl. 95/103

(57) ABSTRACT

A process for separation of carbon dioxide that is present in a gas mixture by pressure-modulated adsorption (PSA) that comprises at least the following stages is described:
a) Bringing said mixture that is to be purified into contact with at least one adsorbent that is formed by a porous carbon material that comprises at least 70% by weight of carbon, whereby said material has a specific surface area that is larger than 1,500 m²/g, a micropore volume of between 0.5 and 2 cm³/g of adsorbent and between 0.5 and 0.8 cm³/cm³ of adsorbent,
b) The adsorption of carbon dioxide on said adsorbent at a total pressure P1,
c) The desorption of at least a portion of CO₂ that is adsorbed in said stage b) so as to produce a CO₂-enriched stream at a total pressure P2 that is less than P1.

### TECHNICAL FIELD OF THE INVENTION

This invention relates to the field of the separation of carbon dioxide that is present in a gas mixture that is to be purified, such as a synthesis gas or natural gas. More precisely, the separation of carbon dioxide is carried out by adsorption by the implementation of a PSA (Pressure Swing Adsorption or pressure-modulated adsorption) process with use of at least one microporous carbon material that is prepared by nano-casting.

### PRIOR ART

The pressure-modulated adsorption process or the PSA process is a process that is commonly used in the field of separation and purification of gases.

The principle of the PSA process is well known to one skilled in the art. It involves a cyclic process that alternates between stages of adsorption, pressure equalization, desorption, and purging. As a general rule, the gas stream that is to be purified passes through the high pressure of the cycle, also called “adsorption pressure,” of the layers or beds of adsorbent materials that preferably retain, by adsorption, the impurity (ies) present in the gas mixture that is to be purified. The adsorption stage leads to the production of a purified gas that essentially consists of a compound that it is desired to obtain in the pure state and that has only slight affinity with the adsorbent bed(s). This (these) impurity (ies) that is (are) adsorbed on the adsorbents during the implementation of the adsorption stage of the PSA process is (are) then extracted from said adsorbent materials by lowering the pressure to a so-called “desorption” pressure during the implementation of the desorption stage of the PSA process. The desorption is first carried out by lowering the pressure and then by flushing the adsorbent bed(s) with an elution gas such that the adsorbed impurity (ies) is (are) desorbed at the desorption pressure. Said desorption stage leads to the production of a residual gas stream that contains the desorbed impurity (ies). The very principle of the PSA process is to cyclically concatenate these adsorption phases at high pressure and these desorption phases at low pressure, optionally with additional stages for equalization of pressure and purging. The operating method of the PSA process is presented in the patent application FR-A-2,910,457. The elution gas is preferably selected from among the compounds of the feedstock that is to be purified.

The processes for purification of gas by PSA are commonly used in the industry. One very important example is the use of the PSA process for the production of high-purity hydrogen (called hydrogen PSA) from the synthesis gas that is formed by a mixture that comprises hydrogen, carbon dioxide (CO₂), carbon monoxide (CO), methane (CH₄) and water (H₂O). A standard PSA process for the purification of hydrogen that is present in a synthesis gas contains several adsorbent beds. As a general rule, first of all an activated carbon bed is used to adsorb the carbon dioxide and then a zeolite bed 5A or NaX is used to adsorb methane, carbon monoxide, and other impurities that are optionally present in the feedstock that consists of the synthesis gas. When water is present in the feedstock, the PSA process can also contain a preliminary silica gel bed so as to pretreat said feedstock and to remove water from it. The purification of hydrogen that is in a mixture in synthesis gas by the implementation of a PSA process leads to the production of a hydrogen-enriched stream (purity that is generally at least 99.5% and even greater than 99.99%) during the adsorption stage and a residual stream that is enriched with CO₂, CO and CH₄ in particular during the desorption stage. For the PSA hydrogen, the elution gas that is used industrially is a portion of the purified hydrogen that is produced during the adsorption stage. It is also possible, however, to use a portion of the purging gas, as described in numerous articles (Diagne, D., Goto, M., Hirosi, T., 1995a. “Experimental Study of Simultaneous Removal and Concentration of CO₂ by an Improved Pressure Swing Adsorption Process.” Energy Conversion and Management 36, 431-434; Ebner, A. D., Ritter, J. A., 2004. “Equilibrium Theory Analysis of Dual Reflux PSA for Separation of a Binary Mixture.” A. I. Ch. E. Journal 50(10), 2418-2429).

Contrary to the processes for purification of H₂ by absorption with a solvent or by a membrane separation, the PSA process makes it possible to obtain an H₂ stream of very high purity (>99.999%). By contrast, the drawback of the PSA process resides in its low H₂ yield (ratio between the flow rate of hydrogen that is produced and the flow rate of hydrogen that is contained in the feedstock to be purified), which is usually between 80 and 90%. The growing needs of hydrogen in the refineries, the petrochemical complexes, and the processes of the energy sector (processes for the production of electricity, such as IGCC (Integrated Gasification Combined Cycle), for example) impose constant research for the purpose of enhancing the performance of the processes for purification of hydrogen by PSA, in particular their yield and their productivity (i.e., the flow rate of hydrogen that is produced relative to the volume or to the mass of adsorbent that is necessary to the separation). Such an improvement is possible by working on the cycle of the PSA process (namely on the concatenation of the stages of adsorption, desorption and equalization of pressure between two columns that contain adsorbent beds) and/or by working on the adsorption properties of the adsorbents. With the CO₂ being one of the primary impurities of the synthesis gas from which it is desired to produce a hydrogen-enriched stream, one of the tracks that are exploited for the purpose of increasing the productivity of the PSA process resides in the search for a better elimination of this impurity.

Another example of the primary use of the PSA process relates to the extraction of the CO₂ that is present in natural gas. Actually, natural gas, at the well outlet, in general contains CO₂, mixed with methane, light hydrocarbons, hydrogen sulfide (H₂S), nitrogen (N₂), water, etc. However, it is important to extract as much CO₂ as possible so as to minimize the flow rates of gas that is to be transported, to increase the calorific value of the gas so as to allow the liquefaction of gas, and to use CO₂ to reinject it into the petroleum wells for the purpose of increasing the rate of recovery of the crude oil. The purities to be achieved depend on the targeted applications. In any case, very large volumes of gas to be treated are involved, and even a minimum enhancement of the performance of the PSA process can allow a significant gain in investment and operational costs. For such an application, the PSA process leads, during the adsorption phase, to the production of a methane-enriched stream, and, during the desorption phase, to a residual stream that is enriched with CO₂ and optionally other impurities that are present in the natural gas.

The PSA process is also used successfully for extracting the carbon dioxide that is present in the biogas. The biogas essentially comprises methane (at least 40% of the volume) that is obtained from the fermentation of various wastes but also contains a large portion of CO₂ that is suitable to separate from methane. In such an application, the PSA process leads, during the adsorption phase, to the production of a methane-enriched stream, and, during the desorption phase, to a residual stream that is enriched with CO₂ and optionally other impurities that are present in the biogas, for example nitrogen.

One of the means for enhancing the performance of a PSA process that is used for the separation of CO₂ that is present in a gas mixture resides in the enhancement of the properties of the adsorbent solid that provides the adsorption of CO₂. By enhancing the performance of an adsorbent toward the radical(s) to be adsorbed, namely toward CO₂ within the scope of the invention, it directly follows an enhancement of the performance of the PSA process.

The performances of an adsorbent are based on two primary parameters: the dynamic adsorption capacity and the adsorption selectivity. Within the scope of this invention, these parameters are examined in view of CO₂, namely the dynamic adsorption capacity of CO₂ and the adsorption selectivity with regard to CO₂.

1. The CO₂ dynamic adsorption capacity is defined as being the difference between the amount of CO₂ that is adsorbed under conditions of the adsorption stage and the amount of CO₂ that remains adsorbed after the desorption stage. The dynamic adsorption capacity is a function of the adsorption isotherms of the various components of the feedstock. By disregarding the kinetic effects, the dynamic adsorption capacity of a given component, for example CO₂, within the framework of this invention, can be estimated by the calculation of the deviation between the adsorbed amount of said component at the adsorption pressure and the amount of said component that remains adsorbed at the desorption pressure.

In the literature, the adsorption capacities are often expressed in mol/kg of adsorbent. By contrast, since the magnitude makes it possible to set the dimensions, the size of an adsorption column in a PSA process is not the adsorption capacity that is expressed in terms of adsorbent mass, but rather the adsorption capacity that is expressed in terms of adsorbent volume. The conversion of the adsorption capacity that is expressed by adsorbent mass in an adsorption capacity that is expressed by adsorbent volume is carried out starting from the density of the adsorbent particle. The density of the particle can be measured by (low-pressure) mercury porosimetry or can be calculated by the formula:

$${ρ}_{particle} = \frac{1}{{V}_{porous} + 1 / {ρ}_{structural}} ,$$

whereby Vₚₒᵣₒᵤₛ is the pore volume of the adsorbent and ρ_{structural} is the structural density that is obtained by pycnometry.

2. The adsorption selectivity with regard to CO₂ corresponds to the ratio between the amount of CO₂ that is adsorbed and that of the other adsorbed impurities, under conditions of operation of the PSA process during the high-pressure adsorption stage. The optimum adsorbent is that which is the most selective with regard to the impurity that is desired for extracting the feedstock.

To enhance the selective adsorption of CO₂, it is therefore a matter of increasing the dynamic adsorption capacity of CO₂ (expressed in moles adsorbed per unit of volume of adsorbent) presented by the adsorbent and/or the selectivity of said adsorbent with regard to CO₂.

The performance levels of a PSA process are characterized primarily by the purifies of the product(s) obtained during the adsorption phase, for example by the hydrogen purity for a process for separating the hydrogen that is present in a synthesis gas, the yield of the product(s) obtained during the adsorption phase (i.e., the discharge flow rate of said product(s) relative to the flow rates of said product(s) contained in the feedstock), and the productivity of the PSA process that corresponds to the flow rate of product(s) formed during the adsorption phase relative to the mass (or to the volume) of adsorbent that is contained in the process. These three characteristics that make it possible to evaluate the performance of a PSA process are connected. The dynamic capacity, which makes it possible to calculate the amount of each impurity that is adsorbed during a cycle of a PSA process, makes it possible to evaluate the amount of adsorbent that is necessary for extracting the desired amount of impurities and therefore to reach the desired process output purity. It is for this reason that the dynamic capacity is the primary dimensioning parameter for a PSA process. The dynamic capacity thus impacts all of the performance levels of the PSA process. Consequently, an increase in the dynamic capacity can make it possible to increase the purity of the product(s) obtained during the adsorption phase, for example hydrogen, the yield of the products(s) obtained during the adsorption phase, for example the hydrogen yield, or the productivity of the process, according to the selection of the operator. In any case, an increase in the dynamic adsorption capacity of the component that it is desired to adsorb preferably makes it possible to enhance the performance of the PSA process and is therefore greatly desired.

The adsorbents that are conventionally used to collect the CO₂ at high/medium pressure (3-20 bar of partial pressure of CO₂) are activated carbons (see, for example, U.S. Pat. No. 4,171,206). The textural properties (pore volume, surface, pore size) of the activated carbons can vary greatly based on the method of preparation (Handbook of Porous Solids, Wiley-VCH, Vol. 3, 2002, p. 1828). As a general rule, the high/medium-pressure adsorption capacity—expressed in moles that are adsorbed per unit of mass of adsorbent—increases when the specific surface area and the pore volume increase (Frost et. Coll., J. Phys. Chem. 110, 2006, 9565). Special treatments have been developed for increasing the pore volume and the specific surface area of activated carbons (T. Ottawa, R. Tanibata, M. Itoh, Gas Separation Purification 1993, 7, 241). It thus is possible to reach a pore volume on the order of 1.8 cm³/g and a specific surface area of larger than 3,000 m²/g. By contrast, the density of this type of material that is known under the trade name Maxsorb is very low (on the order of 0.30 g/cm³). Thus, the adsorption capacity of CO₂ and CH₄ on the Maxsorb solid (conventional activated carbon with high porosity), expressed in terms of mol/kg, is clearly greater than that on conventional activated carbons, starting from a partial pressure of 2 bar (S. Himeno et al., J. Chem. Eng. Data 50, 2005, 369). By contrast, because of the very low density of this material, the adsorption capacity that is measured in mol/volume of adsorbent remains comparable to the conventional activated carbons. Thus, the methods that make it possible to increase the pore volume of the conventional adsorbents do not make it possible to enhance the performance of these adsorbents in terms of adsorption capacity.

The porosity of all of the conventional activated carbons is unorganized. This lack of organization is inherent in the preparation of activated carbons. They are obtained from carbonization, followed by post-treatments, of natural products, such as coal, wood or coconut. Because of this unorganization, the porosity of this type of carbon is always distributed, and at least a portion of the porosity consists of pores with diameters that are not very useful in separation. This is the case, for example, of meso- or macropores (pores with a diameter of larger than 2 nm), in which the adsorbed amounts are small under the usual conditions of operation of a PSA process.

There are also “synthetic” carbons, prepared by the carbonization of chemical precursors. Among the synthetic carbons, the carbon materials that are prepared by nano-casting have very specific and advantageous properties. In particular, the zeolites are particularly attractive nano-casts because they make it possible to obtain microporous carbon replicas of controlled porosity. Several zeolites have been used for nano-casting, for example the following zeolites: beta, L, mordenite, ZSM-5, faujasite, and EMT. The best replicas are obtained with solids that have a porous three-dimensional system and a pore size of larger than 0.6 nm (T. Kyotani et al., Carbon 41, 2003, 1451). The method for preparation of a carbon replica of the faujasite zeolite is described in, for example, T. Kyotani, Bull. Chem. Soc. Japan, 2006, 79, 1322. The replicas of the faujasite can reach a specific surface area of 4,000 m²/g and a microporous volume of 1.8 ml/g.

### SUMMARY AND ADVANTAGE OF THE INVENTION

This invention has as its object a process for separation of carbon dioxide that is present in a gas mixture by pressure-modulated adsorption (PSA) comprising at least the following stages:

a) Bringing said mixture that is to be purified into contact with at least one adsorbent that is formed by at least one porous carbon material that comprises at least 70% by weight of carbon, whereby said material has a specific surface area that is larger than 1,500 m²/g, a microporous volume of between 0.5 and 2 cm³/g of adsorbent and between 0.2 and 0.9 cm³/cm³ of adsorbent,

b) The adsorption of carbon dioxide on said adsorbent at a total pressure P1,

c) The desorption of at least a portion of the CO₂ that is adsorbed in said stage b) so as to produce a CO₂-enriched stream at a total pressure P2 that is less than P1.

Said carbon material that is used as an adsorbent in the separation process of the invention is advantageously prepared according to a method of preparation that uses at least one zeolite and at least one unsaturated organic compound as reagents and that comprises at least one carbonization stage and at least one dissolution stage of said zeolite. Said method of preparation is a process for preparation by nano-casting that leads to obtaining a porous carbon material that has a microporous volume of between 0.5 and 2.0 cm³/g and between 0.2 and 0.9 cm³/cm³.

The separation process according to the invention is particularly advantageous for the separation of the carbon dioxide that is present in a synthesis gas or in the biogas for the purpose of purifying the synthesis gas for producing high-purity hydrogen or of purifying the biogas.

It was discovered that, unexpectedly, said adsorbent that is formed by a porous carbon material, prepared by nano-casting and implemented in a PSA process for the separation of CO₂ that is present in a gas mixture, has a dynamic adsorption capacity of CO₂ that is considerably greater than that of the marketed conventional activated carbons. This significant enhancement of the dynamic adsorption capacity is observed both for the amount of CO₂ that is adsorbed per mass of adsorbent and for the amount of CO₂ that is adsorbed per volume of adsorbent. Said adsorbent that is formed by a porous carbon material, prepared by nano-casting and implemented in the separation process of CO₂ according to the invention, is particularly suitable for the implementation of a PSA process that operates at a high partial pressure of CO₂ (at least 3 bar), i.e., for CO₂-rich feedstocks (in general that have a CO₂ content of at least 40 mol %) or at a high total pressure (between 8 and 70 bar). Furthermore, said adsorbent that is formed by a porous carbon material, prepared by nano-casting and implemented in a PSA process for the separation of CO₂ according to the invention, has an adsorption selectivity with regard to CO₂ that is at least equivalent and even higher than that exhibited by the marketed conventional activated carbons. With the performance levels of the adsorbent that is formed by said porous carbon material, prepared by nano-casting and implemented in a PSA process for the separation of CO₂, being enhanced with regard to the adsorption of CO₂ relative to the performance levels of an adsorbent that is based on a conventional activated carbon, enhancement of the performance levels of the PSA process necessarily ensues. In particular, the increase in the dynamic adsorption capacity of CO₂ that is presented by said adsorbent that is formed by said porous carbon material, prepared by nano-casting, relative to the one that is presented by a conventional activated carbon, makes it possible either to treat the same amount of gas mixture that is to be purified with a lower adsorbent volume or to treat a larger amount of said gas mixture with the same volume of adsorbent. An enhancement of the productivity of the PSA process is derived therefrom.

### DETAILED DESCRIPTION OF THE INVENTION

This invention has as its object a process for separation of carbon dioxide that is present in a gas mixture by pressure-modulated adsorption (PSA) comprising at least one of the following stages:

a) Bringing said mixture that is to be purified into contact with at least one adsorbent that is formed by at least one porous carbon material that comprises at least 70% by weight of carbon, whereby said material has a specific surface area that is larger than 1,500 m²/g, a micropore volume of between 0.5 and 2 cm³/g of adsorbent and between 0.2 and 0.9 cm³/cm³ of adsorbent,

b) The adsorption of carbon dioxide on said adsorbent at a total pressure P1,

c) The desorption of at least a portion of CO₂ that is adsorbed in said stage b) so as to produce a CO₂-enriched stream at a total pressure P2 that is less than P1.

Said porous carbon material that is used as an adsorbent in the separation process of the invention comprises at least 70% by weight of carbon, preferably at least 80% by weight of carbon. It has a specific surface area (determined by the BET method) that is larger than 1,500 m²/g, preferably larger than 2,000 m²/g, and even more preferably larger than 3,000 m²/g. The pore distribution of said carbon material is very fine: it has a micropore volume of between 0.5 and 2.0 cm³/g, preferably between 0.8 and 1.8 cm³/g, and even more preferably between 0.9 and 1.6 cm³/g. This micropore volume, expressed in terms of cm³/g, was determined by the Dubinin-Radushkevich method (Dubinin, M. M.; Radushkevich, L. V. Dokl. Acad. Nauk SSSR 1947, 55, 331). Said carbon material has a micropore volume of between 0.2 and 0.9 cm³/cm³ (pore volume per volume of adsorbent), preferably between 0.5 and 0.8 cm³/cm³. The micropore volume, expressed in terms of cm³/cm³, is obtained from the micropore volume that is expressed in terms of cm³/g and the density of the adsorbent. The density of said porous carbon material is preferably between 0.45 and 0.70 g/cm³. Said porous carbon material that is used as an adsorbent in the process for separation of the invention advantageously offers a porosity that is for the most part macroporous. The micropores represent at least 50% of the total pore volume, preferably at least 65% of the total pore volume, more preferably at least 75% of the total pore volume, and even more preferably at least 85% of the total pore volume of said material. Very preferably, said porous carbon material is advantageously devoid of mesopores. Very preferably, it is also devoid of micropores. The total pore volume of said material is advantageously between 0.5 cm³/g and 2.5 cm³/g, preferably between 0.8 cm³/g and 2.0 cm³/g, and even more preferably between 1.0 cm³/g and 1.8 cm³/g. Expressed in terms of cm³/cm³, said total pore volume is between 0.35 cm³/cm³ and 0.9 cm³/cm³, preferably between 0.55 cm³/cm³ and 0.9 cm³/cm³, and even more preferably between 0.65 cm³/cm³ and 0.8 cm³/cm³.

Said carbon material that is used as an adsorbent in the separation process of the invention advantageously offers a porosity that is organized on the micropore scale. More specifically, it has pores that are organized on the micropore scale having a uniform diameter of between 0.5 and 1.5 nm and distributed homogeneously and uniformly in said porous carbon material. According to the invention, the micropore volume between 0.5 and 2 cm³/g of adsorbent, preferably between 0.8 and 1.8 cm³/g of adsorbent, and between 0.2 and 0.9 cm³/cm³ of adsorbent, preferably between 0.5 and 0.8 cm³/cm³ of adsorbent, corresponds to the volume that is occupied by the pores with a diameter of between 0.5 and 1.5 nm. According to the invention, said micropore volume represents at least 50% of the total pore volume, preferably at least 65% of the total pore volume, more preferably at least 75% of the total pore volume, and even more preferably at least 85% of the total pore volume of said material.

Said carbon material that is used as an adsorbent in the separation process of the invention comes in the form of powder or can be shaped.

Said carbon material that is used as an adsorbent in the separation process of the invention is advantageously prepared according to a method of preparation that uses at least one zeolite and at least one unsaturated organic compound as reagents and that comprises at least one carbonization stage and at least one dissolution stage of said zeolite. Said method of preparation is a process for preparation by nano-casting: at least one zeolite whose porosity is filled in a first step with at least one polymerized organic phase is used. Then, the zeolite is dissolved by an acid treatment, thus creating a porosity within said organic phase that is transformed, by carbonization, into an essentially carbon material. Such a method for preparation of porous carbon material has already been described by T. Kyotani (Bull. Chem. Soc. Japan 2006, 79, 1322). Said zeolite thus plays the role of nano-cast: the porous carbon material that is used as an adsorbent in the separation process of the invention is a negative carbon replica of said zeolite. It is advantageous to use zeolites as nano-casts for the preparation of said porous carbon material to the extent that they lead to obtaining a microporous carbon material. The use of a zeolite that has a perfectly defined microporous crystalline structure and therefore a homogeneous porosity leads to obtaining a porous carbon material that has a porosity that is much more homogeneous and microporous than the conventional activated carbons. Preferably, said porous carbon material has a porosity that is organized on the micropore scale. The degree of organization of the porosity of the porous carbon material is evaluated by x-ray diffraction, in particular by low-angle x-ray diffraction, whereby this technique makes it possible to characterize the periodicity on the nanometric scale that is generated by the organized microporosity of said carbon material. The x-ray analysis is done on powder with a diffractometer that operates by reflection and that is equipped with a rear monochromator by using the radiation of copper (wavelength of 1.5406 Å). The peaks that are usually observed on the diffractograms that correspond to a given value of the angle 2θ are combined with inter-reticular distances d₍ₕₖₗ₎ that are characteristic of the structural symmetry of the material ((hkl) being the Miller indices of the reciprocal network) by Bragg's equation: 2 d₍ₕₖₗ₎*sin (θ)=η*λ. This indexing then makes it possible to determine the parameters (abc) of the direct network. For example and very preferably, the low-angle x-ray diffractogram of said porous carbon material that is used as an adsorbent in the separation process according to the invention has a peak at a distance d₍ₕₖₗ₎ that is close to the one that is present on the diffractogram of the zeolite that is used as a nano-cast. “Close distance d₍ₕₖₗ₎” is defined, in terms of this invention, as a distance between the distance d₍ₕₖₗ₎ of the peak that is observed on the diffractogram of the zeolite at ±10%. Obtaining a diffractogram for the porous carbon material that is close to that of said zeolite reflects the quality with which the process for preparation of said material by nano-casting is carried out.

The process for preparation of said porous carbon material by nano-casting comprises at least the stages:

1) At least one vapor-phase chemical deposition stage of at least one unsaturated organic compound on at least one zeolite at a temperature of between 500 and 800° C.,

2) At least one heat treatment at a temperature of between 850 and 1000° C. for a period of between 1 and 10 hours,

3) The dissolution of said zeolite in excess hydrofluoric acid.

Said zeolite that is used for the implementation of said stage 1) is a zeolite that advantageously has a structural type that is selected from among BEA, MOR, MFI, FAU, LTL and EMT, and, very advantageously, it exhibits the FAU structural type or the EMT structural type. Preferably, said zeolite is selected from among the following zeolites: beta, L, mordenite, ZSM-5, faujasite, Y and EMC-2. Very preferably, said zeolite is a faujasite or an EMC-2 zeolite. Said zeolite preferably comes in a sodic form (Na form). It consists of at least one trivalent element X that is selected from among aluminum, gallium, and the mixture of these two elements, preferably aluminum, and at least one tetravalent element Y that is selected from among silicon, germanium, and the mixture of these two elements, preferably silicon. The Y/X molar ratio, preferably the Si/A1 molar ratio, is between 2 and 100, preferably between 2 and 10.

Said unsaturated organic compound that is used for the implementation of said stage 1) is selected from among olefins, diolefins, and alkynes. Preferably, said unsaturated organic compound is selected from among propylene, butene, butadiene and acetylene. Very preferably, said unsaturated organic compound is propylene or acetylene.

Said stage 1) of the process for preparation by nano-casting of said porous carbon material consists of the implementation of at least one vapor-phase chemical deposition stage (CVD) of at least said unsaturated organic compound on at least said zeolite. Said stage 1) is carried out at a temperature of between 500 and 800° C. for a period of between 1 and 10 hours. Advantageously, said stage 1) is produced by the implementation of two vapor-phase chemical deposition stages of said unsaturated organic compound on said zeolite, whereby the second stage is carried out at a temperature that is preferably higher than the first. The vapor-phase deposition of said unsaturated organic compound, preferably propylene or acetylene, in the porosity of said zeolite is carried out in the presence of a neutral gas such as nitrogen or argon. The amounts of said unsaturated organic compound and said zeolite that are introduced for the implementation of said stage 1) are such that the solid that is obtained at the end of stage 2), explained below, has a content by mass of carbon of between 10 and 25%, preferably between 15 and 20%.

Said stage 2) of the process for preparation by nano-casting of said porous carbon material consists in the implementation of at least one heat treatment at a temperature of between 850 and 1,000° C. for a period of between 1 and 10 hours so as to carbonize the organic material that is introduced into the porosity of said zeolite during said stage 1) and thus to obtain the carbon composition that constitutes said porous carbon material. Very preferably, said stage 2) is carried out for a period of between 2 and 5 hours.

Said stage 3) of the process for preparation by nano-casting of said porous carbon material consists in the dissolution of said zeolite in excess hydrofluoric acid at ambient temperature. Excess hydrofluoric acid is defined as an amount of HF of between 5 and 15 ml per gram of zeolitic solid. This stage leads to creating the microporosity that is present in said porous carbon material. Following said treatment with hydrofluoric acid, the product is filtered, washed with water and dried.

The dissolution of said zeolite according to said stage 3) is advantageously followed by a stage of washing with hydrochloric acid so as to eliminate the parasitic inorganic phases that are optionally produced during the dissolution of the zeolite in the hydrofluoric acid. The treatment with hydrochloric acid is done by initiating reflux-heating of the mixture that is formed by the product that is obtained from said stage 3) and hydrochloric acid. Following said treatment with HCl, the product is filtered, washed with water, and dried. Said porous carbon material is obtained with the structural characteristics that are indicated above in this description.

According to a preferred embodiment of the process for preparation by nano-casting, said stage 1) is preceded by a stage for impregnation of said zeolite by at least one alcohol that is followed by a polymerization stage of said alcohol in the porosity of the zeolite at a temperature of between 60 and 170° C. Prior to the polymerization stage, said impregnation stage is preferably immediately followed by a filtration and washing of the mixed zeolite/alcohol product so as to eliminate the excess alcohol that is deposited on the outside surface of said zeolite. Said impregnation stage is advantageously carried out at a temperature of between 15 and 50° C., very advantageously at ambient temperature.

According to said preferred embodiment of the process for preparation by nano-casting, the alcohol that is used is a polymerizable alcohol. Advantageously, furfurylic alcohol (C₅H₆O₂) is used. It is introduced in an amount that is generally between 3 and 10 ml per gram of zeolite.

According to stage a) of the separation process according to the invention, bringing said gas mixture that is to be purified into contact with at least said adsorbent is carried out in at least one adsorption column that comprises at least one adsorbent bed, preferably at least four adsorbent beds and even more preferably at least two adsorbent beds, whereby each of said beds comprises at least one adsorbent that is formed by said porous carbon material that is prepared by nano-casting. The column is subjected to a pressurization stage by said gas until reaching the pressure P1 at which the adsorption stage of the carbon dioxide is done. Said total pressure P1 at which said adsorption stage b) of the process of the invention is implemented is preferably between 5 and 100 bar, preferably between 5 and 70 bar (1 bar=0.1 MPa). The CO₂ partial pressure in the adsorption stage, according to stage b) of the process according to the invention, is between 3 and 50 bar, preferably between 3 and 20 bar, Said stage b) of the separation process according to the invention leads to the production of a gas stream that is enriched with at least one compound that does not have an affinity for said adsorbent such that it is adsorbed slightly or not at all. Said stage b) of the separation process according to the invention is followed by a desorption stage at a total pressure P2 that is less than P1, whereby said pressure P2 is between 1 and 5 bar. The pressure P2 at which said desorption stage is implemented is less than the CO₂ partial pressure at which the adsorption stage is implemented.

The CO₂ separation process according to the invention is implemented at an operating temperature of between 10° C. and 250° C., preferably between 10° C. and 100° C., and even more preferably between 10° C. and 50° C.

The separation process according to the invention proves very advantageous for the separation of carbon dioxide that is present in synthesis gas so as to purify said gas and to produce a stream of high-purity hydrogen. For the implementation of such a separation process by PSA, said synthesis gas can be obtained from any process for transformation of carbon feedstocks into synthesis gas, such as catalytic vapor reforming, partial oxidation, autothermal reforming and gasification. The composition of the gas mixture that is to be purified can vary based on the origin of the synthesis gas. In a general manner, the elements that are found mixed with hydrogen in the feedstock, i.e., primarily carbon dioxide, carbon monoxide, and optionally methane, water, nitrogen, argon, and heavier hydrocarbides in a very small amount, are combined under the term impurities. Any feedstock that has a composition that is characterized by a major portion (i.e., greater than or equal to 50 mol %) of hydrogen, and a minor portion of impurities based on CO₂, CO and optionally methane, water, nitrogen, argon and heavier hydrocarbons, in any proportions, can advantageously constitute a feedstock of the process according to this invention. Certain impurities, in particular water and H₂S, are preferably adsorbed on an adsorbent bed, for example a silica gel layer, located upstream from at least said adsorbent bed that is formed by at least said porous carbon material so as to pretreat the synthesis gas. Stage b) for adsorption of the process according to the invention leads to the production of a high-purity hydrogen stream while the impurities, in particular carbon dioxide, are adsorbed by the adsorbent bed(s) formed by at least said porous carbon material, prepared by nano-casting, by which said impurities, in particular carbon dioxide, are desorbed at least in part during the desorption phase according to said stage c) of the process of the invention. The effect of this is the production of a CO₂-enriched residual stream. It is recalled that the difference between the amount of CO₂ that is adsorbed under the conditions of the adsorption stage and the amount of CO₂ remaining adsorbed after the desorption stage corresponds to the dynamic adsorption capacity of CO₂ of the adsorbent that is implemented in the PSA process for the adsorption and the desorption of CO₂. Said porous carbon material, prepared by nano-casting, has a dynamic adsorption capacity of CO₂ that is considerably greater than the one that is presented by the conventional carbon materials such as the activated carbons.

The separation process according to the invention also proves very advantageous for the separation of carbon dioxide that is present in the biogas that comprises at least 40% by volume of methane and at least 20% by volume of CO₂. The biogas can also comprise in addition a small amount of carbon monoxide, nitrogen, hydrogen, oxygen and hydrogen sulfide H₂S. In such an application, the adsorption stage b) of said separation process according to the invention leads to the production of a methane-enriched stream, and the desorption stage c) leads to the production of a CO₂-enriched residual stream and optionally other impurities.

The separation process according to the invention also proves very advantageous for the separation of the carbon dioxide that is present in natural gas. Natural gas essentially comprises methane (between approximately 50 and 90% by weight), CO₂ (between 1 and 50% by weight), and impurities such as mercaptans, H₂S, COS, heavier hydrocarbons, and water. In such an application, the adsorption stage b) of said separation process according to the invention leads to the production of a methane-enriched stream, and the desorption stage c) leads to the production of a CO₂-enriched residual stream and optionally other impurities such as those cited above.

It may be advantageous to connect the process according to the invention to another separation process. Thus, the CO₂ concentration can advantageously be increased in the CO₂-rich residual stream by adding a separation process that makes it possible to selectively separate a portion of the molecules that are contained in this stream while keeping the CO₂ under pressure. It thus is possible to consider using a membrane process with a non-selective CO₂ membrane. In this case, the CO₂, for the most part, is recovered in the retentate, therefore at high pressure, while the other compounds are recovered in the permeate at very low pressure.

Likewise, the coupling with another separation process can also make it possible to increase the purity of the CO₂ that is contained in a residual stream of the PSA process according to the invention. This can make it possible to reduce the additional compression costs, for example in the case of CO₂ storage. The increase of the purity of CO₂ can also be advantageous if it is desired to use the CO₂ that is produced for any additional application. Any separation process that makes it possible to selectively extract one of the molecules from the residual stream except for CO₂ while keeping the CO₂-rich stream under pressure can be used. It is possible to cite in particular the membrane processes and the solvent extraction processes.

### EXAMPLES

### Example 1

### Preparation of Microporous Carbon Materials by Nano-Casting

### a) Example 1.a

### Synthesis of a Porous Carbon Material A1 (Microporous Carbon Replica C—Y2.7-Ac-600/700-4/1-HT)

1 g of Na—Y zeolite (Si/A1 ratio=2.7) is deposited in a silica glass nacelle and heated to 600° C. under an argon stream (flow rate of 10 l/h) in a furnace. When the temperature of the furnace has reached 600° C., a mixture of acetylene/argon (5% acetylene by volume—constant total flow rate=10 l/h) is sent into the furnace for 4 hours. The temperature of the furnace is then raised to 700° C. under argon. Then, a mixture of acetylene/argon (5% acetylene by volume—constant total flow rate=10 l/h) is sent into the furnace for 1 hour. The furnace is then placed under a stream of argon at 900° C., and this temperature is kept constant for 4 hours.

The zeolite/carbon composite is placed in the hydrofluoric acid (40% by mass in water—10 ml per 1 g of composite) for 24 hours at ambient temperature. The solid is filtered, washed with water, and dried at 70° C. in air for one night. This stage is followed by treatment in hydrochloric acid (5 ml per 0.1 g of carbon) so as to eliminate the inorganic phases that can form during the dissolution of the zeolite in hydrofluoric acid. The product is mixed with hydrochloric acid and reflux-heated at 80° C. for 4 hours, and then filtered, washed with water, and dried for one night at 70° C.

A microporous carbon solid that is named A1 is thus obtained. It is subjected to several analyses (nitrogen isotherm at 77K, helium pycnometry, DRX, elementary analysis) so as to determine the BET specific surface area, the microporous volume that is expressed in terms of cm³/g and cm³/cm³ as well as the total pore volume that is expressed in terms of cm³/g and cm³/cm³. These structural characteristics of the adsorbent A1 appear in Table 1.

The elementary analysis shows that the adsorbent A1 comprises 81% by weight of carbon.

The diffractogram that is obtained by the DRX analysis has a major peak for 2θ=6.6° or dₕₖₗ=13.38 Å, whereas that of the NaY zeolite shows a peak of maximum intensity for 2θ=6.3° or dₕₖₗ=14.0 Å. The short distance between the peak that is observed on the diffractogram of A1 and that of the zeolite NaY shows the quality of the process for preparation of the material A1 by nano-casting.

### b) Example 1.b

### Synthesis of a Porous Carbon Material A2 (Microporous Carbon Replica C—Y2.7-AF+Ac-600/700-4/1-HT)

1 g of Na—Y zeolite (Si/A1 ratio=2.7) is first of all dried at 150° C. and then degassed under vacuum at 300° C. for 15 hours. The furfurylic alcohol (5 ml of alcohol per 1 g of zeolite, Fluka) is then introduced under reduced pressure and mixed with zeolite for 10 minutes at ambient temperature. The mixture is then stirred for 24 hours under inert nitrogen atmosphere. The zeolite/furfurylic alcohol mixed product is filtered and washed with mesitylene (C₃H₃(CH₃)₃, Fluka) so as to eliminate the furfurylic acid that is deposited on the outside surface of the zeolite. Then, the alcohol is polymerized, under inert atmosphere, at 80° C. for 24 hours and at 150° C. for 8 hours. 1 g of silica/furfurylic polyalcohol composite is deposited in a silica glass nacelle and heated at 600° C. under a stream of argon (flow rate of 10 l/h) in a furnace. When the temperature of the furnace has reached 600° C., an acetylene/argon mixture (5% acetylene by volume—constant total flow rate=10 l/h) is sent into the furnace for 4 hours. The temperature of the furnace is then raised to 700° C. under argon. Then, an acetylene/argon mixture (5% acetylene by volume—total constant flow rate=10 l/h) is sent into the furnace for 1 hour, The furnace is then placed under a stream of argon at 900° C., and this temperature is kept constant for 4 hours.

The zeolite/carbon composite is placed in hydrofluoric acid (40% by mass in water—10 ml per 1 g of composite) for 24 hours at ambient temperature. The solid is filtered, washed with water, and dried at 70° C. in air for one night. This stage is followed by a treatment in hydrochloric acid (5 ml per 0.1 g of carbon) so as to eliminate the inorganic phases that can form during the dissolution of the zeolite in the hydrofluoric acid. The product is mixed with the hydrochloric acid and reflux-heated at 80° C. for 4 hours and then filtered, washed with water, and dried for one night at 70° C.

A microporous carbon solid named A2 is thus obtained. It is subjected to several analyses (nitrogen isotherm at 77K, helium pycnometry, DRX, elementary analysis) so as to determine the BET specific surface area, whereby the microporous volume is expressed in terms of cm³/g and cm³/cm³ as well as the total pore volume that is expressed in terms of cm³/g and cm³/cm³. These structural characteristics of the adsorbent A2 appear in Table 1.

Elementary analysis shows that the adsorbent A2 comprises 82% by weight of carbon.

The diffractogram that is obtained by the DRX analysis exhibits a major peak for 2θ=6.6 or dₕₖₗ=13.38 Å, whereas that of the NaY zeolite shows a peak of maximum intensity for 2θ=6.3° or dₕₖₗ=14.0 Å. The short distance between the peak that is observed on the diffractogram of A2 and that of the NaY zeolite shows the quality of the process for preparation of the material A2 by nano-casting.

### c) Example 1.c

### Synthesis of a Carbon Material A3 (Microporous Carbon Replica C—Y2.7-AF+Ac-650-5-HT)

1 g of Na—Y zeolite (Si/A1 ratio=2.7) is first of all dried at 150° C. and then degassed under vacuum at 300° C. for 15 hours. Furfurylic alcohol (5 ml per 1 g of zeolite, Fluka) is then introduced under reduced pressure and mixed with zeolite for 10 minutes at ambient temperature. The mixture is then stirred for 24 hours under inert nitrogen atmosphere. The mixed product of zeolite/furfurylic alcohol is filtered and washed with mesitylene (C₃H₃(CH₃)₃, Fluka) so as to eliminate the furfurylic alcohol deposited on the outside surface of the zeolite. Then, the alcohol is polymerized, under inert atmosphere, at 80° C. for 24 hours and at 150° C. for 8 hours. 1 g of silica/furfurylic polyalcohol composite is deposited in a silica glass nacelle and heated to 650° C. under an argon stream (flow rate of 10 l/h) in a furnace. When the temperature of the furnace has reached 650° C., an acetylene/argon mixture (5% acetylene by volume—total constant flow rate=10 l/h) is sent into the furnace for 5 hours. The furnace is then placed under a stream of argon at 900° C., and this temperature is kept constant for 4 hours.

The zeolite/carbon composite is placed in hydrofluoric acid (40% by mass in water—10 ml per 1 g of composite) for 24 hours at ambient temperature. The solid is filtered, washed with water, and dried at 70° C. in air for one night. This stage is followed by treatment in hydrochloric acid (5 ml per 0.1 g of carbon) so as to eliminate the inorganic phases that can form during the dissolution of the zeolite in hydrofluoric acid. The product is mixed with hydrochloric acid and reflux-heated at 80° C. for 4 hours, and then filtered, washed with water, and dried for one night at 70° C.

Thus, a microporous carbon solid that is named A3 is obtained. It is subjected to several analyses (nitrogen isotherm at 77K, helium pycnometry, DRX, elementary analysis) so as to determine the BET specific surface area, the micropore volume expressed in terms of cm³/g and cm³/cm³ as well as the total pore volume in terms of cm³/g and cm³/cm³. These structural characteristics of the adsorbent A3 appear in Table 1.

Elementary analysis shows that the adsorbent A3 comprises 81% by weight of carbon.

The diffractogram that is obtained by the DRX analysis exhibits a major peak for 2θ=6.6° or dₕₖₗ=13.38 Å, whereas that of the NaY zeolite shows a peak of maximum intensity for 2θ=6.3° or dₕₖₗ=14.0 Å. The short distance between the peak that is observed on the diffractogram of A3 and that of the NaY zeolite shows the quality of the process for preparation of the material A3 by nano-casting.

TABLE 1
Structural Characteristics of the Adsorbents A1, A2, and A3.

| | | Micropore | Micropore | Total Pore | Total Pore |
|---|---|---|---|---|---|
| Carbon | BET Surface | Volume | Volume | Volume | Volume |
| Materials | Area (m²/g) | (cm³/g) | (cm³/cm³) | (cm³/g) | (cm³/cm³) |
| A1 | 2720 | 1.18 | 0.67 | 1.16 | 0.75 |
| A2 | 3210 | 1.36 | 0.67 | 1.36 | 0.76 |
| A3 | 2260 | 0.95 | 0.57 | 0.85 | 0.71 |

Table 1.1 below will produce the structural characteristics of the conventional activated carbons that are tested in the following examples by way of comparison.

TABLE 1.1
Structural Characteristics of Conventional Activated Carbons

| | | Total Pore | Total Pore |
|---|---|---|---|
| | BET Surface Area | Volume | Volume |
| Activated Carbons | (m²/g) | (cm³/g) | (cm³/cm³) |
| Norit R 1 Extra (Norit) | 1450 | 0.47 | 0.20 |
| BPL (Calgon Corp.) | 1150 | 0.43 | 0.21 |
| Maxsorb (Kansai Coke and | 3250 | 1.79 | 0.52 |
| Chemicals) | | | |
| A10 Fiber | 1200 | 0.53 | 0.11 |
| Activated Carbon A | 1207 | 0.54 | 0.32 |

The Supelco Company markets carbon molecular sieves including the referenced sieve C-1021, which has a pore size of less than 0.56 nm, a BET surface area that is equal to 695 m²/g, a micropore volume that is equal to 0.28 cm³/g, and a total pore volume that is equal to 0.35 cm³/g. This commercial sieve C-1021, although exhibiting a porosity that is for the most part microporous, has a small micropore volume, expressed in terms of cm³/g.

### Example 2

This example illustrates the dynamic adsorption capacity of CO₂ of each of the microporous carbon materials A1, A2 and A3, prepared in Example 1, and that of conventional activated carbons.

The dynamic adsorption capacity of CO₂ is evaluated experimentally by measurements of “piercing curves”: the gas mixture that consists of CO₂ and an inert gas (nitrogen) is injected at 25° C. at a given flow rate in a column that contains a bed of adsorbent A1, or adsorbent A2 or A3. The concentrations at the output of each of the components of the feedstock are measured over time, until all of the concentrations stabilize at their input values (saturation of the adsorbent bed). The curves that represent the concentrations of components as a function of time are called “piercing curves.” The mean output time of the piercing curve of CO₂ makes it possible to calculate its adsorbed amount by the well-known method called “moments” (Ruhven, D. M. Principles of Adsorption and Adsorption Processes. John Wiley & Sons, Ed., 1984). The dynamic capacity of the adsorbent A1, or of the adsorbent A2 and A3, is evaluated by repeating this operation at high pressure (adsorption pressure) and at low pressure (desorption pressure) of the process, and by subtracting the amount of CO₂ that is adsorbed at low pressure from that adsorbed at high pressure. The results appear in Table 2.

The test that is described above is reproduced for the determination of the dynamic adsorption capacity of CO₂ of conventional activated carbons. The results appear in Table 2.

Table 2 below has dynamic adsorption capacity values of CO₂ for a partial pressure of CO₂ by adsorption of 5 bar and a partial pressure of CO₂ by desorption of 1 bar.

TABLE 2
Dynamic Adsorption Capacities of CO₂ of the Microporous
Carbon Materials A1, A2 and A3 (Invention) and Conventional
Activated Carbons between 5 and 1 Bar

| Carbon Materials | CO₂ Dynamic Capacity (mmol/cm³) |
|---|---|
| A1 | 4.3 |
| A2 | 3.35 |
| A3 | 3.3 |
| Norit R 1 Extra | 1.6 |
| BPL | 1.2 |
| Maxsorb | 1.7 |
| A10 Fiber | 0.7 |
| Activated Carbon A | 1.8 |

The results that appear in Table 2 demonstrate that the microporous carbon materials A1, A2 and A3 that are prepared by nano-casting have a dynamic adsorption capacity (in terms of mol/cm³) that is considerably greater than that of all of the conventional activated carbons. As explained above in this description, the performance levels of a PSA process are directly proportional to the dynamic adsorption capacity of CO₂; the effect of this is that the productivity of a PSA process that is used for the separation of the CO₂ that is present in a gas mixture will be higher with the adsorbents A1, A2 and A3 than with the adsorbents that are based on conventional activated carbons.

### Example 3

Just as in Example 2, this Example 3 illustrates the dynamic adsorption capacity of CO₂ of each of the microporous carbon materials A1, A2 and A3, prepared in Example 1, and that of the conventional activated carbons. In this example, the PSA process was carried out at an adsorption pressure that corresponds to the partial pressure of CO₂ that is equal to 10 bar and a desorption pressure that is equal to 2 bar. The operating temperature of the PSA is equal to 25° C.

The dynamic adsorption capacity of CO₂ of the adsorbents A1, A2 and A3 is determined in a manner that is analogous to that described in Example 2, according to the well-known method that is called “moments.” The results are recorded in Table 3.

Table 3 also has the dynamic adsorption capacity of CO₂ of conventional activated carbons, tested under the same operating conditions of the PSA (P_{CO2 adsorption}=10 bar, P_{desorption}=2 bar, T=25° C.). The determination of the dynamic adsorption capacity of CO₂ of each of the conventional activated carbons was carried out in a manner analogous to that described in Example 2.

TABLE 3
Dynamic Adsorption Capacities of CO₂ of the Microporous
Carbon Materials A1, A2 and A3 (Invention) and Conventional
Activated Carbons between 10 and 2 Bar

| Carbon Materials | CO₂ Dynamic Capacity (mmol/cm³) |
|---|---|
| A1 | 5.2 |
| A2 | 5.0 |
| A3 | 6.0 |
| Norit R 1 Extra | 1.4 |
| BPL | 1.2 |
| Maxsorb | 2.0 |
| A10 Fiber | 0.6 |
| Activated Carbon A | 1.9 |

Just as for Example 2, the results that appear in Table 3 show that the microporous carbon materials A1, A2 and A3 that are prepared by nano-casting have a dynamic adsorption capacity (in mol/cm³) that is considerably greater than that of all of the conventional activated carbons. In addition, the increase of the adsorption pressure and the desorption pressure leads to a dynamic adsorption capacity of CO₂ that is increased for each of the adsorbents A1, A2 and A3, whereas the conventional activated carbons do not have a better dynamic adsorption capacity with the increase of the adsorption pressure and the desorption pressure. This example demonstrates that the microporous carbon solids A1, A2 and A3 can be implemented in a PSA process that operates at a high adsorption pressure and a high desorption pressure.

### Example 4

This example illustrates the adsorption selectivity with regard to the CO₂ of each of the microporous carbon materials A1, A2 and A3 and that of conventional activated carbons, tested in the adsorption of CO₂ and CH₄. The selectivity corresponds to the ratio of the amount of CO₂ that is adsorbed on an adsorbent that is provided to the amount of CH₄ that is adsorbed on this same adsorbent. In this example, the selectivity has been calculated relative to the Henry constants of CO₂ and CH₄. The Henry constant of CO₂ represents the initial slope of the adsorption isotherm of CO₂, and the Henry constant of CH₄ represents the initial loop of the adsorption isotherm of CH₄

Table 4 shows the selectivity of each of the microporous carbon materials A1, A2 and A3 as well as that of conventional activated carbons with regard to CO₂ relative to CH₄.

TABLE 4
CO₂/CH₄ Selectivity of the Microporous Carbon Materials
A1, A2 and A3 (Invention) and of Conventional Activated Carbons

| Carbon Materials | CO₂/CH₄ Selectivity |
|---|---|
| A1 | 2.9 ± 0.5 |
| A2 | 3.0 ± 2 |
| A3 | 3.0 ± 0.7 |
| Norit R 1 Extra | 1.9 |
| Maxsorb | 1.9 |
| A10 Fiber | 2.2 |
| Activated Carbon A | 2.2 |

The results that appear in Table 4 demonstrate that the microporous carbon materials A1, A2 and A3 that are prepared by nano-casting have a selectivity with regard to CO₂ that is equivalent and even greater than that of the conventional activated carbons. However, Examples 2 and 3 demonstrated that said microporous carbon materials have a dynamic adsorption capacity of CO₂ that is considerably enhanced relative to that of the conventional activated carbons. The effect of this is therefore an enhancement of the productivity of a PSA process that implements the separation of CO₂ that is present in a gas mixture.

### Example 5

The performance levels of the PSA process according to the invention are verified in this example for the separation of CO₂ that is present in a synthesis gas that is obtained from the vapor reforming of methane. The composition of the gas mixture that is to be purified is as follows (% mol): 65% H₂, 25% CO₂, 5% CO, and 5% CH₄.

Said gas mixture is purified by passing through a column that contains an adsorbent bed A1, or adsorbent A2 or A3. The total adsorption pressure is equal to 24 bar, the desorption stage is carried out at 1 bar, and the operating temperature of the PSA is equal to 25° C. In the desorption stage, for each test that is implemented on each of the adsorbents A1, A2 and A3, a stream that consists of 92±1 mol % of CO₂, 6±1 mol % of CH₄ and 2±1 mol % of CO is recovered at 1 bar.

The amounts of CO₂, CH₄ and CO that are co-adsorbed on each of the microporous carbon materials A1, A2 and A3 under the conditions of the adsorption stage and the desorption stage have been calculated by using the theory of ideal solutions (Myers, Prausnitz, AICHE Journal, Vol. 11, 1965, 121). It is considered that hydrogen is not adsorbed. The results appear in Table 5.

Table 5 also has the dynamic adsorption capacity of CO₂ of the commercial activated carbon BPL that is used, by way of comparison, in the separation of CO₂ that is present in a synthesis gas that has the composition given above. The BPL is commonly used in PSA processes (see, for example, U.S. Pat. No. 4,171,206). The dynamic capacity of CO₂, equal to 1.1 mmol/cm³, has been calculated starting from data of the literature (Wilson, Danner, J. Chem. Eng. Data 1983, 28, 14).

TABLE 5
Dynamic Adsorption Capacity in CO₂ Mixed with CH₄, CO, and
H₂ of the Microporous Carbon Materials A1, A2 and A3 (Invention)
and a Commercial Activated Carbon

| Carbon Materials | Dynamic Capacity of CO₂ (mmol/cm³) |
|---|---|
| A1 | 3.0 |
| A2 | 2.9 |
| A3 | 2.75 |
| BPL | 1.1 |

The results that appear in Table 5 demonstrate that even mixed with methane, carbon monoxide and hydrogen, the dynamic adsorption capacity of CO₂ of each of the microporous carbon materials A1, A2 and A3 is much better than that of the commercial activated carbon BPL (Wilson, Danner, J. Chem. Eng. Data 1983, 28, 14). This difference in dynamic capacity of CO₂ will be reflected by a considerable enhancement of the performance of a PSA process that is used for the separation of CO₂ that is present in the synthesis gas.

### Example 6

This example illustrates the separation of the CO₂ that is present in the biogas by a PSA process. The composition by volume of the biogas is the following: 54% CH₄, 42% CO₂ and 4% N₂. Traces of other impurities (H₂S, volatile organic compounds, etc.) can be present in the biogas but have been eliminated from the composition of the biogas upstream from the implementation of the PSA process.

The biogas is purified by passing through a column that contains a bed of adsorbent A1, or adsorbent A2 or A3. The total adsorption pressure is equal to 8 bar; the desorption stage is carried out at 1 bar, and the operating temperature of the PSA is equal to 25° C. In the desorption stage, for each test that is implemented on each of the adsorbents A1, A2 and A3, a stream that consists of 62-72% by volume of CO₂, 27-37% by volume of CH₄ and <1% by volume of N₂ is recovered at 1 bar.

The amounts of CO₂ and CH₄ that are co-adsorbed on each of the microporous carbon materials A1, A2 and A3 under the conditions of the adsorption stage and the desorption stage have been calculated by using the theory of ideal solutions (Myers, Prausnitz, AICHE Journal, Vol. 11, 1965, 121). The results appear in Table 6.

TABLE 6
Dynamic Adsorption Capacity of CO₂ Mixed with CH₄ and N₂ of the
Microporous Carbon Materials A1, A2 and A3

| Carbon Materials | Dynamic Capacity of CO₂ (mmol/cm³) |
|---|---|
| A1 | 2.2 |
| A2 | 2.2 |
| A3 | 2.0 |

The results that appear in Table 6 demonstrate that each of said microporous carbon materials A1, A2 and A3 have a satisfactory dynamic adsorption capacity of CO₂. These results demonstrate the advantage in using said microporous carbon materials in a PSA process that is used for the implementation of the separation of CO₂ that is present in the biogas.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

The entire disclosures of all applications, patents and publications, cited herein and of corresponding French application No. 09/03.009, filed Jun. 22, 2009, are incorporated by reference herein.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. Process for separation of carbon dioxide that is present in a gas mixture by a pressure-modulated adsorption (PSA) that comprises at least the following stages:
a) Bringing said mixture that is to be purified into contact with at least one adsorbent that is formed by at least one porous carbon material that comprises at least 70% by weight of carbon, whereby said material has a specific surface area that is larger than 1,500 m²/g, a micropore volume of between 0.5 and 2 cm³/g of adsorbent and between 0.2 and 0.9 cm³/cm³ of adsorbent, whereby the micropores represent at least 75% of the total pore volume of said material,
b) The adsorption of carbon dioxide on said adsorbent at a total pressure P1,
c) The desorption of at least a portion of CO₂ that is adsorbed in said stage b) so as to produce a CO₂-enriched stream at a total pressure P2 that is less than P1.

2. Process for separation according to claim 1, such that said porous carbon material has a micropore volume of between 0.8 and 1.8 cm³/g.

3. Process for separation according to claim 1, such that said porous carbon material has a micropore volume that is between 0.9 and 1.6 cm³/g.

4. Process for separation according to claim 1, such that said porous carbon material has a micropore volume of between 0.5 and 0.8 cm³/cm³.

5. Process for separation according to claim 1, such that said material comes in powder form or is shaped.

6. Process for separation according to claim 1, such that said porous carbon material is prepared according to a process that comprises at least the stages:
1) At least one vapor-phase chemical deposition stage of at least one unsaturated organic compound on at least one zeolite at a temperature of between 500 and 800° C.,
2) At least one heat treatment at a temperature of between 850 and 1,000° C. for a period of between 1 and 10 hours,
3) The dissolution of said zeolite in excess hydrofluoric acid.

7. Separation process according to claim 6, such that said zeolite that is used for the implementation of said stage 1) is a zeolite that has a structural type that is selected from among BEA, MOR, MFI, FAU, LTL and EMT.

8. Separation process according to claim 6, such that said unsaturated organic compound that is used for the implementation of said stage 1) is selected from among olefins, diolefins and alkynes.

9. Separation process according to claim 6, such that said stage 1) is preceded by a stage for impregnation of said zeolite by at least one alcohol that is followed by a polymerization stage of said alcohol in the porosity of the zeolite at a temperature of between 60 and 170° C.

10. Separation process according to claim 9, such that said alcohol is furfurylic alcohol.

11. Separation process according to claim 1, such that said total pressure P1 that is implemented for said adsorption stage b) is between 5 and 100 bar.

12. Separation process according to claim 1, such that said total pressure P2 is between 1 and 5 bar.

13. Separation process according to claim 1, such that said gas mixture is a synthesis gas.

14. Separation process according to claim 1, such that said gas mixture is the biogas that comprises at least 40% by volume of methane and at least 20% by volume of CO₂.

15. Separation process according to claim 1, such that said gas mixture is natural gas.
